(19) United States
(12) Patent Application Publication
(10) Pub. No.: US 2016/0019839 A1
(43) Pub. Date: Jan. 21, 2016

(54) METHOD OF OPERATING AN ORGANIC LIGHT-EMITTING DIODE (OLED) DISPLAY AND OLED DISPLAY

(71) Applicant: Samsung Display Co., Ltd., Yongin-city (KR)

(72) Inventor: Hai-Jung IN, Seoul (KR)

(21) Appl. No.: 14/578,861

(22) Filed: Dec. 22, 2014

(30) Foreign Application Priority Data
Jul. 17, 2014 (KR) 10-2014-0090192

(51) Int. Cl. G09G 3/32

(52) U.S. Cl. CPC G09G 3/3258; G09G 3/3275; G09G 3/3266; G09G 2330/021; G09G 2330/028

(57) ABSTRACT

A method of operating an organic light-emitting diode (OLED) display and an OLED display are disclosed. In one aspect, the method includes measuring an extent of degradation of the OLEDs and determining a power supply voltage increment based at least in part on the measured extent of degradation. The method further includes increasing a power supply voltage applied to the pixels by the determined power supply voltage increment and increasing the high data voltage and the low data voltage in proportion to the determined power supply voltage increment.

### CROSS-REFERENCE TO RELATED APPLICATION(S)

This application claims priority under 35 USC §119 to Korean Patent Applications No. 10-2014-0090192, filed on Jul. 17, 2014 in the Korean Intellectual Property Office (KIPO), the contents of which are incorporated herein in its entirety by reference.

### BACKGROUND

1. Field

The described technology generally relates to a method of operating an organic light-emitting diode (OLED) display and an OLED display.

2. Description of the Related Technology

The standard OLED display is driven via an active matrix driving technique which can be categorized into an analog driving technique or a digital driving technique. Analog driving techniques produce grayscale data values having variable voltage levels. Also, the manufacture of an integrated circuit (IC) driver that can perform the analog driving technique has proven to be difficult for larger and higher resolution panels.

The digital driving technique produces grayscale values by causing an OLED to emit light with a variable time duration. In comparison to analog driving techniques, a simpler IC structure can be used to implement the digital driving technique. Therefore, the digital driving technique may be more suitable for high resolution panels. Also, digital driving techniques operate based on the on- and off-states of a driving thin film transistor (TFT) which may be influenced less by image quality deterioration as a result of TFT characteristic deviations. Therefore, digital driving techniques may be more suitable larger size panels.

### SUMMARY OF CERTAIN INVENTIVE ASPECTS

One inventive aspect is a method of operating an OLED display that can reduce the power consumption of a data driving unit.

Another aspect is a display device that can reduce the power consumption of a data driving unit.

Another aspect is a method of operating an OLED display configured to drive an OLED included in a pixel to selectively emit light by applying a high data voltage or a low data voltage to the pixel. In the method, a power supply voltage increment is determined by measuring an extent of degradation of the OLED such that the determined power supply voltage increment corresponds to the measured extent of degradation. A power supply voltage applied to the pixel is increased by the determined power supply voltage increment. The high data voltage and the low data voltage are increased in proportion to the determined power supply voltage increment.

In some example embodiments, each of the high data voltage and the low data voltage may be increased by the determined power supply voltage increment.

In some example embodiments, each of an initial voltage level of the high data voltage and an initial voltage level of the low data voltage may be set based on an initial voltage level of the power supply voltage.

In some example embodiments, the initial voltage level of the high data voltage may be set based on a difference between the initial voltage level of the power supply voltage and a voltage level of a threshold voltage of a driving transistor included in the pixel.

In some example embodiments, the initial voltage level of the low data voltage may be set to have a predetermined difference with respect to the initial voltage level of the power supply voltage.

In some example embodiments, a high scan voltage and a low scan voltage applied to the pixel may be further increased in proportion to the determined power supply voltage increment.

In some example embodiments, each of the high scan voltage and the low scan voltage may be increased by the determined power supply voltage increment.

In some example embodiments, an initial voltage level of the high scan voltage may be set based on an initial voltage level of the high data voltage and an initial voltage level of the low scan voltage may be set based on an initial voltage level of the low data voltage.

Another aspect is a method of operating an OLED display configured to drive OLED included in a pixel to selectively emit light by applying a high data voltage or a low data voltage to the pixel. In the method, a power supply voltage increment is determined by measuring an extent of degradation of the OLED such that the determined power supply voltage increment corresponds to the measured extent of degradation. A power supply voltage applied to the pixel is increased by the determined power supply voltage increment. The high data voltage and the low data voltage are increased in proportion to the determined power supply voltage increment. A high scan voltage and a low scan voltage applied to the pixel are increased in proportion to the determined power supply voltage increment.

In some example embodiments, each of the high data voltage and the low data voltage may be increased by the determined power supply voltage increment.

In some example embodiments, each of an initial voltage level of the high data voltage and an initial voltage level of the low data voltage may be set based on an initial voltage level of the power supply voltage.

In some example embodiments, each of the high scan voltage and the low scan voltage may be increased by the determined power supply voltage increment.

In some example embodiments, an initial voltage level of the high scan voltage may be set based on an initial voltage level of the high data voltage and an initial voltage level of the low scan voltage may be set based on an initial voltage level of the low data voltage.

Another aspect is an OLED display including a display unit including a pixel having an OLED, a data driving unit configured to apply a high data voltage or a low data voltage to the pixel such that the OLED to selectively emits light, a degradation measuring unit configured to measure an extent of degradation of the OLED, and to determine a power supply voltage increment corresponding to the measured extent of degradation, a power supply unit configured to apply a power supply voltage to the pixel, and to increase the power supply voltage by the determined power supply voltage increment, and a voltage control unit configured to provide the high data voltage and the low data voltage to the data driving unit, and to increase the high data voltage and the low data voltage in proportion to the determined power supply voltage increment.

In some example embodiments, the voltage control unit may increase each of the high data voltage and the low data voltage by the determined power supply voltage increment.

In some example embodiments, each of an initial voltage level of the high data voltage and an initial voltage level of the low data voltage may be set based on an initial voltage level of the power supply voltage.

In some example embodiments, the OLED display may further include a scan driving unit configured to apply a high scan voltage and a low scan voltage to the pixel.

In some example embodiments, the voltage control unit may provide the high scan voltage and the low scan voltage to the scan driving unit and may increase the high scan voltage and the low scan voltage in proportion to the determined power supply voltage increment.

In some example embodiments, the voltage control unit may increase each of the high scan voltage and the low scan voltage by the determined power supply voltage increment.

In some example embodiments, an initial voltage level of the high scan voltage may be set based on an initial voltage level of the high data voltage and an initial voltage level of the low scan voltage may be set based on an initial voltage level of the low data voltage.

Another aspect is a method of operating an organic light-emitting diode (OLED) display including a plurality of pixels, each including an OLED, the pixels configured to selectively emit light based at least in part on a high data voltage or a low data voltage respectively applied to the pixels, the method comprising measuring an extent of degradation of the OLEDs; determining a power supply voltage increment based at least in part on the measured extent of degradation; increasing a power supply voltage applied to the pixels by the determined power supply voltage increment; and increasing the high data voltage and the low data voltage in proportion to the determined power supply voltage increment.

In example embodiments, each of the high data voltage and the low data voltage is increased by the determined power supply voltage increment. Each of an initial voltage level of the high data voltage and an initial voltage level of the low data voltage can be set based at least in part on an initial voltage level of the power supply voltage. The initial voltage level of the high data voltage can be set based at least in part on a difference between the initial voltage level of the power supply voltage and a threshold voltage of a driving transistor included in each of the pixels. The initial voltage level of the low data voltage can be set to have a predetermined difference with respect to the initial voltage level of the power supply voltage.

In example embodiments, the method further comprises increasing a high scan voltage and a low scan voltage applied to the pixels in proportion to the determined power supply voltage increment. Each of the high scan voltage and the low scan voltage can be increased by the determined power supply voltage increment. An initial voltage level of the high scan voltage can be set based at least in part on an initial voltage level of the high data voltage and an initial voltage level of the low scan voltage can be set based at least in part on an initial voltage level of the low data voltage.

Another aspect is a method of operating an organic light-emitting diode (OLED) display including a plurality of pixels, each including an OLED, the pixels configured to selectively emit light based at least in part on a high data voltage or a low data voltage respectively applied to the pixels, the method comprising measuring an extent of degradation of the OLEDs; determining a power supply voltage increment based at least in part on the measured extent of degradation; increasing a power supply voltage applied to the pixels by the determined power supply voltage increment; increasing the high data voltage and the low data voltage in proportion to the determined power supply voltage increment; and increasing a high scan voltage and a low scan voltage applied to the pixels in proportion to the determined power supply voltage increment.

In example embodiments, each of the high data voltage and the low data voltage is increased by the determined power supply voltage increment. Each of an initial voltage level of the high data voltage and an initial voltage level of the low data voltage can be set based at least in part on an initial voltage level of the power supply voltage. Each of the high scan voltage and the low scan voltage can be increased by the determined power supply voltage increment. An initial voltage level of the high scan voltage can be set based at least in part on an initial voltage level of the high data voltage and an initial voltage level of the low scan voltage can be set based at least in part on an initial voltage level of the low data voltage.

Another aspect is an organic light-emitting diode (OLED) display, comprising a display panel including a plurality of pixels, each including an OLED; a data driver configured to apply a high data voltage or a low data voltage to each of the pixels; a degradation measuring unit configured to i) measure an extent of degradation of the OLEDs and ii) determine a power supply voltage increment corresponding to the measured extent of degradation; a power supply configured to i) apply a power supply voltage to each of the pixels and ii) increase the power supply voltage by the determined power supply voltage increment; and a voltage controller configured to i) provide the high data voltage and the low data voltage to the data driver and ii) increase the high data voltage and the low data voltage in proportion to the determined power supply voltage increment.

In example embodiments, the voltage controller is further configured to increase each of the high data voltage and the low data voltage by the determined power supply voltage increment. Each of an initial voltage level of the high data voltage and an initial voltage level of the low data voltage can be set based at least in part on an initial voltage level of the power supply voltage. The OLED display can further comprise a scan driver configured to apply a high scan voltage and a low scan voltage to each of the pixels. The voltage controller can be further configured to i) provide the high scan voltage and the low scan voltage to the scan driver and ii) increase the high scan voltage and the low scan voltage in proportion to the determined power supply voltage increment. The voltage controller can be further configured to increase each of the high scan voltage and the low scan voltage by the determined power supply voltage increment. An initial voltage level of the high scan voltage can be set based at least in part on an initial voltage level of the high data voltage and an initial voltage level of the low scan voltage can be set based at least in part on an initial voltage level of the low data voltage

### BRIEF DESCRIPTION OF THE DRAWINGS

Illustrative, non-limiting example embodiments will be more clearly understood from the following detailed description taken in conjunction with the accompanying drawings.

FIG. 1 is a flowchart illustrating a method of operating an OLED display in accordance with example embodiments.

FIG. 2 is a graph illustrating a luminance plot of an OLED according to a power supply voltage before and after degradation of the OLED.

FIG. 3 is a circuit diagram illustrating an example of a pixel included in an OLED display in accordance with example embodiments.

FIG. 4 is a diagram for describing a swing width of a data voltage before and after degradation of an OLED in an OLED display where a high data voltage and a low data voltage have fixed voltage levels.

FIG. 5 is a diagram for describing a swing width of a data voltage before and after degradation of an OLED in an OLED display where a high data voltage and a low data voltage are increased according to an extent of the degradation of the OLED in accordance with example embodiments.

FIG. 6 is a flowchart illustrating a method of operating an OLED display in accordance with example embodiments.

FIG. 7 is a timing diagram illustrating a power supply voltage, a data voltage and a scan voltage before and after degradation of an OLED.

FIG. 8 is a block diagram illustrating an OLED display in accordance with example embodiments.

FIG. 9 is a block diagram illustrating an electronic device including an OLED display in accordance with example embodiments.

### DETAILED DESCRIPTION OF CERTAIN INVENTIVE EMBODIMENTS

In the standard digital driving technique, an OLED of a pixel selectively emits light in response to one of a high data voltage and a low data voltage. In this digital driving technique, the high data voltage and the low data voltage should have a voltage difference sufficient to turn on or off the driving transistor included in the pixel, and thus a data driver has large power consumption. Further, in the standard OLED display, since the high data voltage and the low data voltage have fixed voltage levels, the high data voltage and the low data voltage should have sufficient margins to ensure that the driving transistor is turned on or off even if a power supply voltage is increased to accommodate the extent of degradation of the OLEDs, which results in the increase of the power consumption of the data driver.

The example embodiments are described more fully hereinafter with reference to the accompanying drawings. Like or similar reference numerals refer to like or similar elements throughout.

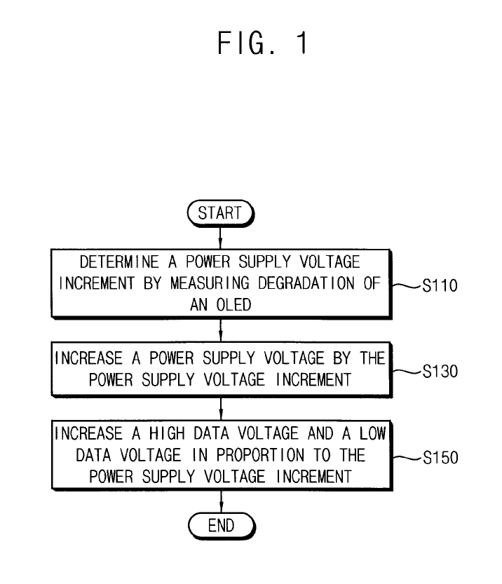

FIG. 1 is a flowchart illustrating a method of operating an organic light-emitting diode (OLED) display in accordance with example embodiments.

Referring to FIG. 1, in the method of operating an OLED display including a plurality of pixels, each including an OLED, the pixels configured to selectively emit light based at least in part on a high data voltage or a low data voltage respectively applied to the pixels, the extent of degradation of the OLED is measured and a power supply voltage increment is determined based on the measured extent of degradation (S110). In some example embodiments, the OLED display accumulates image data for the pixel and can measure (or estimate) the extent of degradation of the OLED based on the accumulated image data. In other example embodiments, the OLED display measures the luminance of the OLED to measure the extent of degradation of the OLED. In still other example embodiments, to measure the extent of degradation of the OLED, the OLED display measures a current flowing through the OLED when a predetermined voltage is applied to the OLED. However, the measurement of the extent of degradation of the OLED is not limited thereto, and can be performed in various other manners.

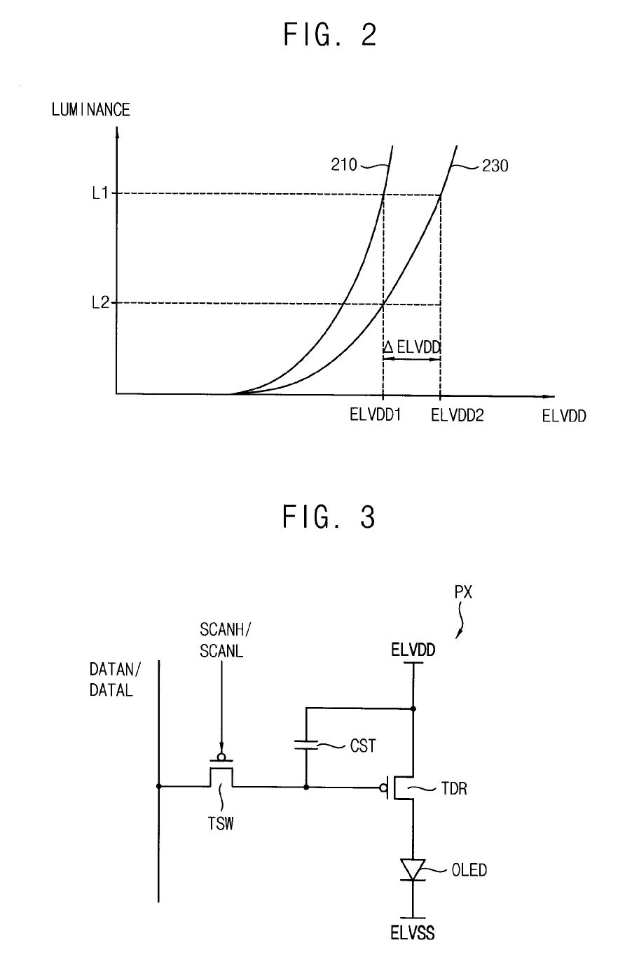

The OLED display can determine the power supply voltage increment corresponding to the extent of degradation of the OLED such that the luminance of the OLED after the degradation is substantially the same as the luminance of the OLED before the degradation. For example, as illustrated in FIG. 2, the luminance 230 of the OLED after the degradation according to a power supply voltage ELVDD may be decreased compared with the luminance 210 of the OLED before the degradation according to the power supply voltage ELVDD. In an example, the OLED before the degradation has a desired first luminance L1 at a first power supply voltage ELVDD1, but the OLED after the degradation has a second luminance L2 lower than the first luminance L1 at the first power supply voltage ELVDD1. In this situation, the OLED display according to example embodiments provides the pixel including the OLED with a second power supply voltage ELVDD2 that is increased by the power supply voltage increment ΔELVDD determined corresponding to the extent of degradation of the OLED from the first power supply voltage ELVDD1 such that the OLED after the degradation has the first luminance L1 that is a desired luminance. That is, the power supply voltage ELVDD applied to the pixel is increased by the power supply voltage increment ΔELVDD determined corresponding to the extent of degradation so that the luminance of the OLED can be maintained with substantially the same level before and after the degradation.

The OLED display increases the power supply voltage applied to the pixel by the determined power supply voltage increment (S130). Accordingly, when the OLED is degraded, the luminance of the OLED is prevented from decreasing or deteriorating.

The OLED display increases a high data voltage and a low data voltage applied to the pixel in proportion to the determined power supply voltage increment (S150). Thus, as the power supply voltage increases, the OLED display increases both of the high data voltage and the low data voltage.

In some example embodiments, the OLED display increases each of the high data voltage and the low data voltage by the determined power supply voltage increment. That is, the OLED display increases the power supply voltage, the high data voltage and the low data voltage by substantially the same increment. In the OLED display according to example embodiments, in contrast to a standard OLED display where a high data voltage and a low data voltage are fixed and the fixed high and low data voltages are set to have voltage levels with predetermined margins for the increase of the power supply voltage, in at least one embodiment, the power supply voltage, the high data voltage and the low data voltage are increased by substantially the same increment, and thus the high data voltage and the low data voltage are set to have optimal voltage levels without the margins or with small margins.

Hereinafter, in an OLED display where the high and low data voltages are fixed and in an OLED display where the high and low data voltages are adjusted according to example embodiments, the high and low data voltages before and after the degradation of the OLED will be described below with reference to FIGS. 3 through 5.

Referring to FIG. 3, each pixel PX included in an OLED display driven with a digital driving method includes a switching transistor TSW, a storage capacitor CST, a driving transistor TDR and an OLED. The switching transistor TSW receives a high scan voltage SCANH or a low scan voltage SCANL and transfers a high data voltage DATAH or a low data voltage DATAL applied through a data line to the storage capacitor CST in response to the low scan voltage SCANL. The storage capacitor CST stores the high data voltage DATAH or the low data voltage DATAL received from the switching transistor TSW. The driving transistor TDR is selectively turned on or off based on a voltage stored in the storage capacitor CST. For example, the driving transistor TDR is turned on when the low data voltage DATAL is stored in the storage capacitor CST and is turned off when the high data voltage DATAH is stored in the storage capacitor CST. The OLED selectively emits light according to whether the driving transistor TDR is turned on or off. For example, when the driving transistor TDR is turned off, the OLED does not emit light. When the driving transistor TDR is turned on, a current path is formed from a high power supply voltage ELVDD to a low power supply voltage ELVSS, and thus the OLED emits light. In the OLED display according to example embodiments, since the high and low data voltages DATAH and DATAL are not fixed and are increased as a power supply voltage (e.g., the high power supply voltage ELVDD) is increased, the high and low data voltages DATAH and DATAL are set to have optimal voltage levels.

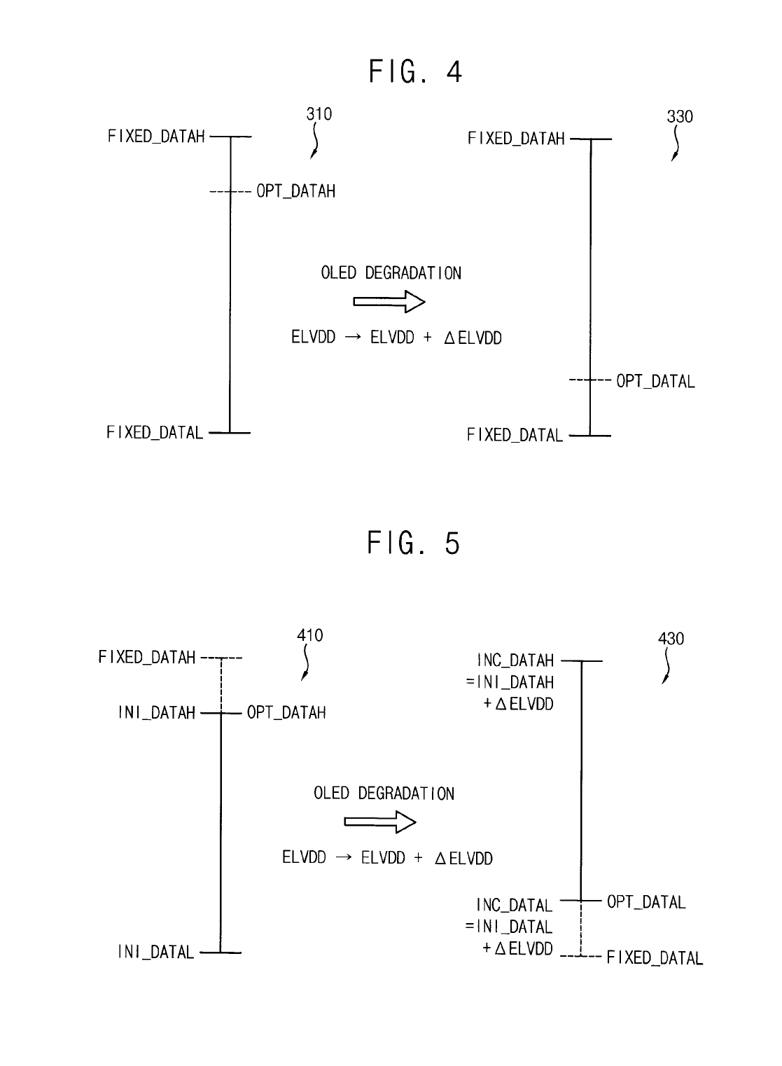

For example, as illustrated in FIG. 4, when the high and low data voltages DATAH and DATAL applied to the pixel PX are fixed high and low data voltages FIXED_DATAH and FIXED_DATAL, the fixed high data voltage FIXED_DATAH is higher than an optimal high data voltage OPT_DATAH in a data voltage range 310 before the OLED is degraded. Although, before the degradation of the OLED, the fixed high data voltage FIXED_DATAH can be set to have the same voltage level as the optimal high data voltage OPT_DATAH which allows the driving transistor TDR to be turned off, the fixed high data voltage FIXED_DATAH, however, should be set to have a voltage level higher than that of the optimal high data voltage OPT_DATAH to ensure that the driving transistor TDR is turned off when the power supply voltage ELVDD is increased after the degradation of the OLED.

Further, as illustrated in FIG. 4, when the high and low data voltages DATAH and DATAL applied to the pixel PX are the fixed high and low data voltages FIXED_DATAH and FIXED_DATAL, the fixed low data voltage FIXED_DATAL is lower than an optimal low data voltage OPT_DATAL in a data voltage range 330 after the OLED is degraded. After the degradation of the OLED, even when the fixed low data voltage FIXED_DATAL is set to have the same voltage level as the optimal low data voltage OPT_DATAL, the voltage level of the fixed low data voltage FIXED_DATAL may be sufficiently low for respective pixels which have electrical characteristic deviations (e.g., turn-on resistance deviations of the driving transistors TDR) to have uniform luminance. However, the fixed low data voltage FIXED_DATAL should be set to have a voltage level lower than that of the optimal low data voltage OPT_DATAL to ensure that the respective pixels PX have uniform luminance when the power supply voltage ELVDD is not increased before the degradation of the OLED.

As described above, in the OLED display having the fixed high and low data voltages FIXED_DATAH and FIXED_DATAL, since the fixed high and low data voltages FIXED_DATAH and FIXED_DATAL should be set to have predetermined margins with respect to the optimal high and low data voltages OPT_DATAH and OPT_DATAL, the data voltage FIXED_DATAH and FIXED_DATAL applied to the pixel PX have a large swing width. Accordingly, a data driving unit or data driver has unnecessary power consumption and the charge/discharge time of data lines is greater than necessary.

However, in the OLED display according to example embodiments, an initial voltage level of the low data voltage DATAL is set based on an initial voltage level of the power supply voltage ELVDD (i.e., a voltage level of the power supply voltage ELVDD before the degradation of the OLED) and an initial voltage level of the high data voltage DATAH is set also based on the initial voltage level of the power supply voltage ELVDD. For example, the initial voltage level of the high data voltage DATAH is set based on a difference between the initial voltage level of the power supply voltage ELVDD and a voltage level of a threshold voltage of the driving transistor TDR included in the pixel PX. Further, the initial voltage level of the low data voltage DATAL is set to have a predetermined difference with respect to the initial voltage level of the power supply voltage ELVDD, where the predetermined difference allows the respective pixels which have electrical characteristic deviations (e.g., turn-on resistance deviations of the driving transistors TDR) to have uniform luminance.

For example, as illustrated in FIG. 5, in the OLED display according to example embodiments, before the degradation of the OLED, the data voltages DATAH and DATAL applied to the pixel PX have a data voltage range 410 including initial high and low data voltages INI_DATAH and INI_DATAL corresponding to the power supply voltage ELVDD that is not increased. Thus, in the OLED display according to example embodiments, the initial high data voltage INI_DATAH before the degradation of the OLED is substantially the same as the optimal high data voltage OPT_DATAH and is lower than the fixed high data voltage FIXED_DATAH.

Further, as illustrated in FIG. 5, in the OLED display according to example embodiments, after the degradation of the OLED, the data voltage DATAH and DATAL applied to the pixel PX have a data voltage range 430 including increased high and low data voltages INC_DATAH and INC_DATAL corresponding to the increased power supply voltage ELVDD+ΔELVDD. That is, when the power supply voltage ELVDD is increased by the power supply voltage increment ΔELVDD corresponding to the extent of degradation of the OLED, the high data voltage DATAH is increased by the power supply voltage increment ΔELVDD from the initial high data voltage INI_DATAH to the increased high data voltage INC_DATAH and the low data voltage DATAL is increased by the power supply voltage increment ΔELVDD from the initial low data voltage INI_DATAL to the increased low data voltage INC_DATAL. In this embodiment, since the high and low data voltages DATAH and DATAL are increased by the power supply voltage increment ΔELVDD, a gate-source voltage of the driving transistor TDR is not changed in spite of the increase of the power supply voltage ELVDD, and thus the driving transistor TDR can operate normally without a change in characteristics (e.g., turn-on or turn-off characteristics) of the driving transistor TDR. In particular, in the OLED display according to example embodiments, the increased low data voltage INC_DATAL after the degradation of the OLED is substantially the same as the optimal low data voltage OPT_DATAL and is higher than the fixed low data voltage FIXED_DATAL.

In the OLED display according to example embodiments, since the high and low data voltages DATAH and DATAL are increased as the power supply voltage ELVDD is increased, the high and low data voltages DATAH and DATAL are set to have a small voltage range 410 and 430 without the predetermined margins for the increase of the power supply voltage ELVDD. Accordingly, the high and low data voltages DATAH and DATAL applied to the pixel PX have a small swing width, a data driving unit does not have unnecessary power consumption and the charge/discharge time of data lines can be reduced with respect to the standard display. Although FIGS. 3 through 5 illustrate examples where each pixel PX includes PMOS transistors, in some example embodiments, each pixel PX of the OLED display includes NMOS transistors.

As described above, in the method of operating the OLED display according to example embodiments, the high and low data voltages are increased in proportion to the increment of the power supply voltage, which results in the reduction of the power consumption of the data driving unit and the reduction of the charge/discharge time of the data lines.

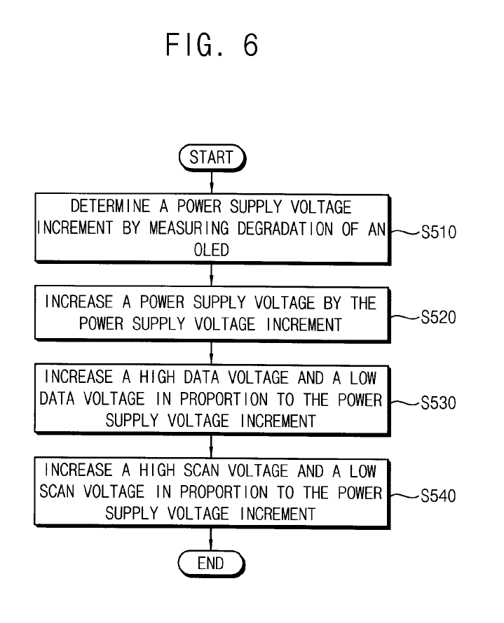

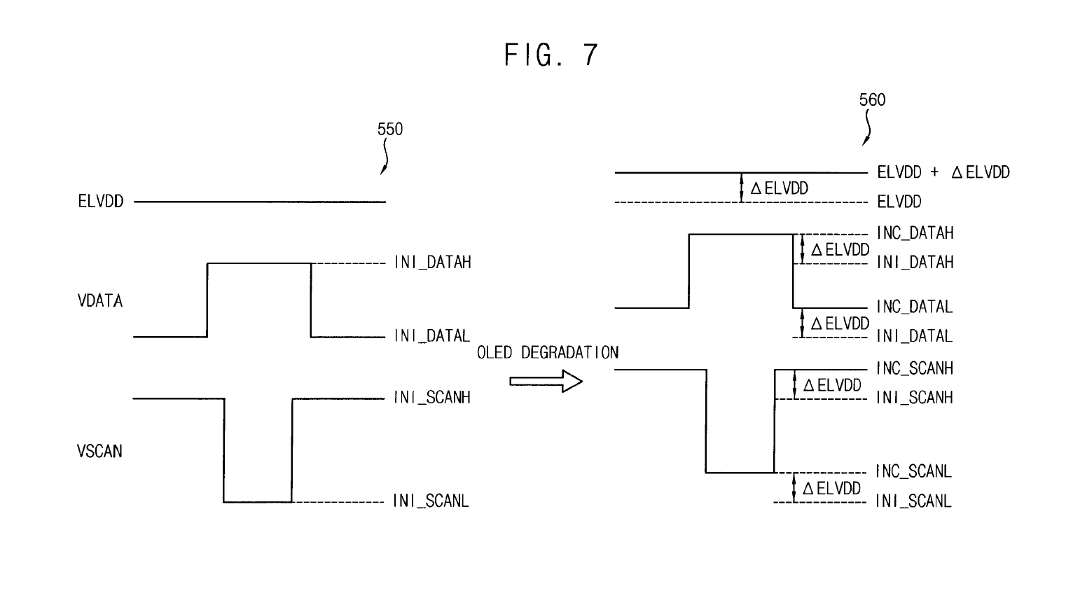

FIG. 6 is a flowchart illustrating a method of operating an OLED display in accordance with example embodiments and FIG. 7 is a timing diagram illustrating a power supply voltage, a data voltage and a scan voltage before and after degradation of an OLED.

In the method of the operating the OLED display illustrated in FIG. 6, high and low scan voltages are further increased compared with the method of the operating the OLED display illustrated in FIG. 1.

Referring to FIG. 6, in the method of operating the OLED display including a plurality of pixels, each including an OLED, the pixels configured to selectively emit light based at least in part on a high data voltage or a low data voltage respectively applied to the pixels, an extent of degradation of the OLED is measured and a power supply voltage increment is determined based on the measured extent of degradation (S510). The OLED display increases the power supply voltage applied to the pixel by the determined power supply voltage increment (S520). Further, the OLED display increases a high data voltage and a low data voltage applied to the pixel in proportion to the determined power supply voltage increment (S530). In the OLED display according to example embodiments, since the high and low data voltages are increased as the power supply voltage is increased, the high and low data voltages are set to have a small voltage range without the predetermined margins for the increase of the power supply voltage. Accordingly, the high and low data voltages applied to the pixel have a small swing width, a data driving unit does not have unnecessary power consumption and a charge/discharge time of data lines is reduced.

Further, the OLED display increases a high scan voltage and a low scan voltage applied to the pixel in proportion to the determined power supply voltage increment (S540). Thus, as the power supply voltage is increased, the OLED display increases both of the high scan voltage and the low scan voltage.

In some example embodiments, the OLED display increases each of the high data voltage and the low data voltage by the determined power supply voltage increment and further increases each of the high scan voltage and the low scan voltage by the determined power supply voltage increment. That is, according to these embodiments, the OLED display increases the power supply voltage, the high data voltage, the low data voltage, the high scan voltage and the low scan voltage by substantially the same increment. In the OLED display according to example embodiments, since the power supply voltage, the high data voltage, the low data voltage, the high scan voltage and the low scan voltage are increased by substantially the same increment, the high data voltage, the low data voltage, the high scan voltage and the low scan voltage are set to have optimal voltage levels without the margins or with small margins.

Hereinafter, in an OLED display where the high and low data voltages and the high and low scan voltages are adjusted according to example embodiments, the high and low data voltages and the high and low scan voltages before and after the degradation of the OLED will be described below with reference to FIGS. 3 and 7.

In an OLED display where the data voltages DATAH and DATAL and the scan voltages SCANH and SCANL are fixed, the high and low data voltages DATAH and DATAL may be set to have predetermined margins for the increase of the power supply voltage ELVDD according to the degradation of the OLED. In this situation, the high and low scan voltages SCANH and SCANL may be set to have a large swing width corresponding to the high and low data voltages DATAH and DATAL having the predetermined margins. For example, the high scan voltage SCANH should be set to have a voltage level that is sufficiently high for the switching transistor TSW to be turned off even if the high data voltage DATAH having the predetermined margin is stored in the storage capacitor CST. Further, the low scan voltage SCANL should be set to have a voltage level that is sufficiently low for the switching transistor TSW to transfer the low data voltage DATAL having the predetermined margin to the storage capacitor CST. As described above, in the OLED display where the data voltages DATAH and DATAL and the scan voltages SCANH and SCANL are fixed, the scan voltages SCANH and SCANL should have a large swing width corresponding to the large swing width of the data voltages DATAH and DATAL. Accordingly, a scan driving unit or scan driver may have unnecessary power consumption and a charge/discharge time of a scan line may be increased.

However, in the OLED display according to example embodiments, as illustrated in a timing diagram 550 of FIG. 7, before the degradation of the OLED, the data voltage VDATA includes initial high and low data voltages INI_DATAH and INI_DATAL having initial voltage levels set based on an initial voltage level of the power supply voltage ELVDD and the scan voltage VSCAN includes initial high and low scan voltages INI_SCANH and INI_SCANL having initial voltage levels set based on the initial voltage levels of the initial high and low data voltages INI_DATAH and INI_DATAL. Thus, since the initial high and low data voltages INI_DATAH and INI_DATAL are set without the predetermined margins for the increase of the power supply voltage ELVDD, the data voltage VDATA has a small swing width when compared to the standard OLED display. Further, since the initial high and low scan voltages INI_SCANH and INI_SCANL are set based on the initial high and low data voltages INI_DATAH and INI_DATAL having the small swing width, the scan voltage VSCAN also have a small swing width when compared to the standard OLED display. Accordingly, the data driving unit and the scan driving unit do not have unnecessary power consumption and the charge/discharge time of the data line and the scan line is reduced.

In the OLED display according to example embodiments, the data voltage VDATA and the scan voltage VSCAN are increased as the power supply voltage ELVDD is increased according to the degradation of the OLED. For example, as illustrated in a timing diagram 560 of FIG. 7, when the power supply voltage ELVDD is increased by the power supply voltage increment ΔELVDD corresponding to the extent of degradation of the OLED, the high data voltage DATAH is increased by the power supply voltage increment ΔELVDD from the initial high data voltage INI_DATAH to the increased high data voltage INC_DATAH, the low data voltage DATAL is increased by the power supply voltage increment ΔELVDD from the initial low data voltage INI_DATAL to the increased low data voltage INC_DATAL, the high scan voltage SCANH is increased by the power supply voltage increment ΔELVDD from the initial high scan voltage INI_SCANH to the increased high scan voltage INC_SCANH, and the low scan voltage SCANL is increased by the power supply voltage increment ΔELVDD from the initial low scan voltage INI_SCANL to the increased low scan voltage INC_SCANL. In this embodiment, since the high and low data voltages DATAH and DATAL are increased by the power supply voltage increment ΔELVDD, a gate-source voltage of the driving transistor TDR is not changed in spite of the increase of the power supply voltage ELVDD, and thus the driving transistor TDR normally operates without a change in characteristics (e.g., turn-on or turn-off characteristic) of the driving transistor TDR. Further, since the high and low scan voltages SCANH and SCANL are increased by the increment (i.e., the power supply voltage increment ΔELVDD) of the high and low data voltages DATAH and DATAL, a gate-source voltage of the switching transistor TSW is not changed in spite of the increase of the data voltage VDATA, and thus the switching transistor TSW normally operates without a change in characteristics (e.g., turn-on or turn-off characteristic) of the switching transistor TSW.

In the OLED display according to example embodiments, since the high and low data voltages DATAH and DATAL are increased as the power supply voltage ELVDD is increased, the data voltage VDATA is set to have a small swing width (or a small voltage range) without the predetermined margins for the increase of the power supply voltage ELVDD. Further, since the high and low scan voltages SCANH and SCANL are increased as the data voltage VDATA is increased, the scan voltage VSCAN also has a small swing width (or a small voltage range) corresponding to the small swing width of the data voltage VDATA. Accordingly, since the data voltage VDATA and the scan voltage VSCAN applied to the pixel PX have small swing widths, the data driving unit and the scan driving unit do not have the unnecessary power consumption and the charge/discharge time of the data line and the scan line can be reduced.

As described above, in the method of operating the OLED display according to example embodiments, the high and low data voltages and the high and low scan voltages are increased in proportion to the increment of the power supply voltage, which results in the reduction of the power consumption of the data driving unit and the scan driving unit, and the reduction of the charge/discharge time of the data line and the scan line.

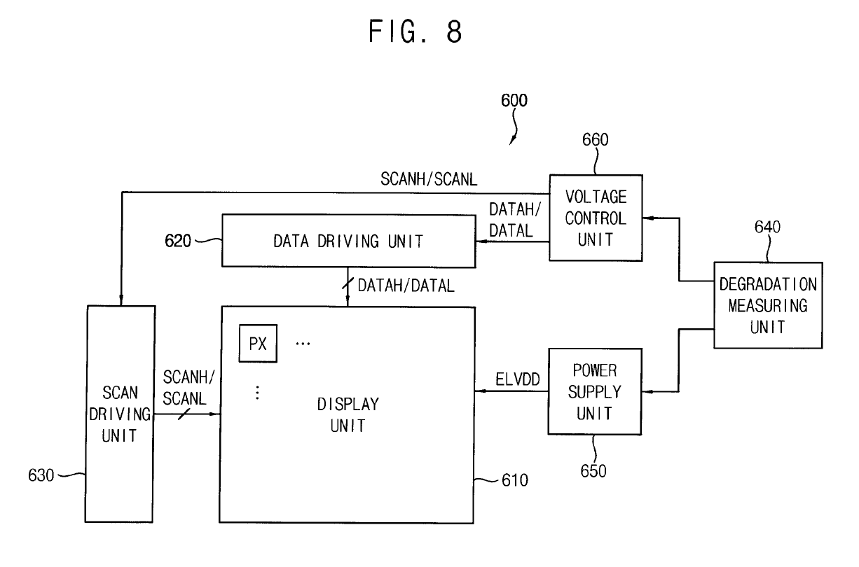

FIG. 8 is a block diagram illustrating an OLED display in accordance with example embodiments.

Referring to FIG. 8, an OLED display 600 includes a display unit or display panel 610 including a pixel PX having an OLED, a data driving unit or data driver 620 that applies a high data voltage DATAH or a low data voltage DATAL to the pixel PX, and a degradation measuring unit 640 that measures an extent of degradation of the OLED. The OLED display 600 further includes a power supply unit or power supply 650 that applies a power supply voltage ELVDD to the pixel PX, and a voltage control unit or voltage controller 660 that provides the high data voltage DATAH and the low data voltage DATAL to the data driving unit 620. The OLED display 600 further includes a scan driving unit or scan driver 630 that applies a high scan voltage SCANH or a low scan voltage SCANL to the pixel PX.

The display unit 610 is connected to the data driving unit 620 through a plurality of data lines and is connected to the scan driving unit 630 through a plurality of scan lines. The display unit 610 includes the plurality of pixels PX located at the intersections between the data lines and the scan lines.

The data driving unit 620 applies the high data voltage DATAH or the low data voltage DATAL to the respective pixels PX included in the display unit 610 through the data lines and each pixel PX emits or does not emit light in response to the high data voltage DATAH or the low data voltage DATAL. The scan driving unit 630 applies the high scan voltage SCANH or the low scan voltage SCANL to the respective pixels PX included in the display unit 610 through the scan lines and a switching transistor included in each pixel PX is turned on or off in response to the high scan voltage SCANH or the low scan voltage SCANL.

The degradation measuring unit 640 measures an extent of degradation of the OLED included in the pixel PX. In some example embodiments, the degradation measuring unit 640 accumulates image data for the pixel PX and measures (or estimates) the extent of degradation of the OLED based on the accumulated image data. In other example embodiments, the degradation measuring unit 640 measures luminance of the OLED to measure the extent of degradation of the OLED. In still other example embodiments, to measure the extent of degradation of the OLED, the degradation measuring unit 640 measures a current flowing through the OLED when a predetermined voltage is applied to the OLED.

In some example embodiments, the degradation measuring unit 640 determines a power supply voltage increment based on the measured extent of degradation of the OLED. For example, the degradation measuring unit 640 determines the power supply voltage increment such that the luminance of the OLED can be maintained with substantially the same level before and after the degradation.

The power supply unit 650 applies the power supply voltage ELVDD to the pixel PX, and increases the power supply voltage ELVDD by the determined power supply voltage increment. According to example embodiments, the determination of the power supply voltage increment corresponding to the measured extent of degradation is performed by the degradation measuring unit 640, by the power supply unit 650, or any other components of the OLED display 600.

The voltage control unit 660 provides the high data voltage DATAH and the low data voltage DATAL to the data driving unit 620 and increases the high data voltage DATAH and the low data voltage DATAL in proportion to the determined power supply voltage increment. In some example embodiments, the voltage control unit 660 increases each of the high data voltage DATAH and the low data voltage DATAL by the determined power supply voltage increment. For example, each of an initial voltage level of the high data voltage DATAH and an initial voltage level of the low data voltage DATAL is set based on an initial voltage level of the power supply voltage ELVDD and each of the high data voltage DATAH and the low data voltage DATAL is increased by the same amount as the power supply voltage ELVDD. Accordingly, the data voltage DATAH and DATAL have a small swing width, the data driving unit 620 does not have unnecessary power consumption, and a charge/discharge time of the data line can be reduced.

In some example embodiments, the voltage control unit 660 provides the high scan voltage SCANH and the low scan voltage SCANL to the scan driving unit 630, and also increases the high scan voltage SCANH and the low scan voltage SCANL in proportion to the determined power supply voltage increment. In some example embodiments, the voltage control unit 660 increases each of the high scan voltage and the low scan voltage by the determined power supply voltage increment. For example, an initial voltage level of the high scan voltage SCANH is set based on the initial voltage level of the high data voltage DATAH, an initial voltage level of the low scan voltage SCANL is set based on the initial voltage level of the low data voltage DATAL, and each of the high scan voltage SCANH and the low scan voltage SCANL is increased by the same amount as the data voltages DATAH and DATAL, or the power supply voltage ELVDD. Accordingly, the scan voltages SCANH and SCANL have a small swing width, the scan driving unit 630 does not have unnecessary power consumption, and a charge/discharge time of the scan line can be reduced.

According to example embodiments, the power supply unit 650 and the voltage control unit 660 are implemented as one voltage converting unit, or as different voltage converting units. For example, the power supply unit 650 and the voltage control unit 660 can be implemented as one DC-DC converter, or as different DC-DC converters.

In some embodiments, the OLED display 600 further includes a timing control unit or timing controller that controls operations of the OLED display 600.

As described above, in the OLED display 600 according to example embodiments, the high and low data voltages DATAH and DATAL are increased in proportion to the increment of the power supply voltage ELVDD, which results in the reduction of the power consumption of the data driving unit 620, and the reduction of the charge/discharge time of the data line. Further, in some example embodiments, the high and low scan voltages SCANH and SCANL are increased in proportion to the increment of the power supply voltage ELVDD, which results in the reduction of the power consumption of the scan driving unit 630, and the reduction of the charge/discharge time of the scan line.

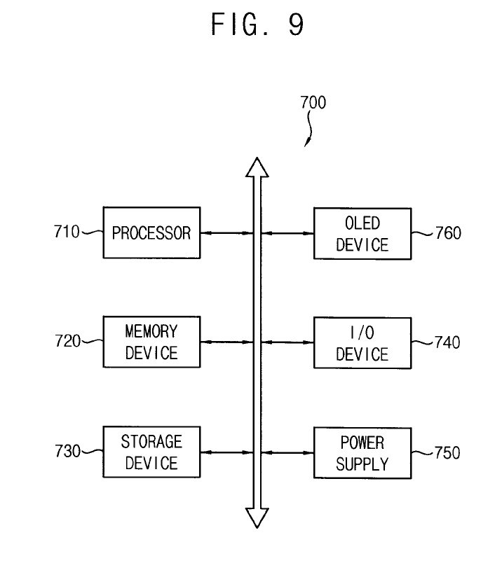

FIG. 9 is a block diagram illustrating an electronic device including an OLED display in accordance with example embodiments.

Referring to FIG. 9, an electronic device 700 includes a processor 710, a memory device or memory 720, a storage device 730, an input/output (I/O) device 740, a power supply 750, and an OLED display 960. The electronic device 700 may further include a plurality of ports for communicating a video card, a sound card, a memory card, a universal serial bus (USB) device, other electric devices, etc.

The processor 710 performs various computing functions. The processor 710 may be a microprocessor, a central processing unit (CPU), etc. The processor 710 may be connected to other components via an address bus, a control bus, a data bus, etc. Further, in some example embodiments, the processor 710 may be connected to an extended bus such as a peripheral component interconnection (PCI) bus.

The memory device 720 stores data for operations of the electronic device 700. For example, the memory device 720 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile dynamic random access memory (mobile DRAM) device, etc.

The storage device 730 may be a solid state drive device, a hard disk drive device, a CD-ROM device, etc. The I/O device 740 may be an input device such as a keyboard, a keypad, a mouse, a touch screen, etc, and an output device such as a printer, a speaker, etc. The power supply 750 may supply power for operations of the electronic device 700.

The OLED display 760 can communicate with other components via the buses or other communication links. The OLED display 760 increases high and low data voltages in proportion to an increment of a power supply voltage, which results in the reduction of power consumption of a data driving unit, and the reduction of a charge/discharge time of a data line. Further, in some example embodiments, the OLED display 760 increases high and low scan voltages in proportion to the increment of the power supply voltage, which results in the reduction of power consumption of a scan driving unit, and the reduction of a charge/discharge time of a scan line.

The described technology may be applied to any electronic device including an OLED display. For example, the described technology may be applied to a television, a computer monitor, a laptop, a digital camera, a cellular phone, a smart phone, a personal digital assistant (PDA), a portable multimedia player (PMP), a MP3 player, a navigation system, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the inventive technology. Accordingly, all such modifications are intended to be included within the scope of the invention as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of operating an organic light-emitting diode (OLED) display including a plurality of pixels, each including an OLED, the pixels configured to selectively emit light based at least in part on a high data voltage or a low data voltage respectively applied to the pixels, the method comprising:
measuring an extent of degradation of the OLEDs;
determining a power supply voltage increment based at least in part on the measured extent of degradation;
increasing a power supply voltage applied to the pixels by the determined power supply voltage increment; and
increasing the high data voltage and the low data voltage in proportion to the determined power supply voltage increment.

2. The method of claim 1, wherein each of the high data voltage and the low data voltage is increased by the determined power supply voltage increment.

3. The method of claim 1, wherein each of an initial voltage level of the high data voltage and an initial voltage level of the low data voltage is set based at least in part on an initial voltage level of the power supply voltage.

4. The method of claim 3, wherein the initial voltage level of the high data voltage is set based at least in part on a difference between the initial voltage level of the power supply voltage and a threshold voltage of a driving transistor included in each of the pixels.

5. The method of claim 3, wherein the initial voltage level of the low data voltage is set to have a predetermined difference with respect to the initial voltage level of the power supply voltage.

6. The method of claim 1, further comprising:
increasing a high scan voltage and a low scan voltage applied to the pixels in proportion to the determined power supply voltage increment.

7. The method of claim 6, wherein each of the high scan voltage and the low scan voltage is increased by the determined power supply voltage increment.

8. The method of claim 6, wherein an initial voltage level of the high scan voltage is set based at least in part on an initial voltage level of the high data voltage and wherein an initial voltage level of the low scan voltage is set based at least in part on an initial voltage level of the low data voltage.

9. A method of operating an organic light-emitting diode (OLED) display including a plurality of pixels, each including an OLED, the pixels configured to selectively emit light based at least in part on a high data voltage or a low data voltage respectively applied to the pixels, the method comprising:
measuring an extent of degradation of the OLEDs;
determining a power supply voltage increment based at least in part on the measured extent of degradation;
increasing a power supply voltage applied to the pixels by the determined power supply voltage increment;
increasing the high data voltage and the low data voltage in proportion to the determined power supply voltage increment; and
increasing a high scan voltage and a low scan voltage applied to the pixels in proportion to the determined power supply voltage increment.

10. The method of claim 9, wherein each of the high data voltage and the low data voltage is increased by the determined power supply voltage increment.

11. The method of claim 9, wherein each of an initial voltage level of the high data voltage and an initial voltage level of the low data voltage is set based at least in part on an initial voltage level of the power supply voltage.

12. The method of claim 9, wherein each of the high scan voltage and the low scan voltage is increased by the determined power supply voltage increment.

13. The method of claim 9, wherein an initial voltage level of the high scan voltage is set based at least in part on an initial voltage level of the high data voltage and wherein an initial voltage level of the low scan voltage is set based at least in part on an initial voltage level of the low data voltage.

14. An organic light-emitting diode (OLED) display, comprising:
a display panel including a plurality of pixels, each including an OLED;
a data driver configured to apply a high data voltage or a low data voltage to each of the pixels;
a degradation measuring unit configured to i) measure an extent of degradation of the OLEDs and ii) determine a power supply voltage increment corresponding to the measured extent of degradation;
a power supply configured to i) apply a power supply voltage to each of the pixels and ii) increase the power supply voltage by the determined power supply voltage increment; and
a voltage controller configured to i) provide the high data voltage and the low data voltage to the data driver and ii) increase the high data voltage and the low data voltage in proportion to the determined power supply voltage increment.

15. The OLED display of claim 14, wherein the voltage controller is further configured to increase each of the high data voltage and the low data voltage by the determined power supply voltage increment.

16. The OLED display of claim 14, wherein each of an initial voltage level of the high data voltage and an initial voltage level of the low data voltage is set based at least in part on an initial voltage level of the power supply voltage.

17. The OLED display of claim 14, further comprising:
a scan driver configured to apply a high scan voltage and a low scan voltage to each of the pixels.

18. The OLED display of claim 17, wherein the voltage controller is further configured to i) provide the high scan voltage and the low scan voltage to the scan driver and ii) increase the high scan voltage and the low scan voltage in proportion to the determined power supply voltage increment.

19. The OLED display of claim 18, wherein the voltage controller is further configured to increase each of the high scan voltage and the low scan voltage by the determined power supply voltage increment.

20. The OLED display of claim 19, wherein an initial voltage level of the high scan voltage is set based at least in part on an initial voltage level of the high data voltage and wherein an initial voltage level of the low scan voltage is set based at least in part on an initial voltage level of the low data voltage.
